(19) United States
(12) Patent Application Publication
(10) Pub. No.: US 2013/0199350 A1
(43) Pub. Date: Aug. 8, 2013

(54) PORTABLE APPARATUS FOR CUTTING TILES OR THE LIKE

(71) Applicant: Pekka Salmi, Riihimaki (FI)

(72) Inventor: Pekka Salmi, Riihimaki (FI)

(21) Appl. No.: 13/520,367

(22) PCT Filed: Dec. 14, 2010
(86) PCT No.: PCT/FI10/51028

§ 371 Date: Sep. 21, 2012

(30) Foreign Application Priority Data
Jan. 8, 2010 (FI) 20105012

(51) Int. Cl. B28D 1/22

(52) U.S. Cl. CPC B28D 1/22
USPC 83/370; 83/468.7

(57) ABSTRACT

The invention relates to a portable apparatus for cutting tiles (5) or the like. The cutting apparatus comprises a housing part (20), inside which there is fitted a carriage part (6), which is arranged to be moved in a power-driven manner by a motor means (11) provided in the housing part. A replaceable cutting blade (2) is fixed to the carriage part for moving with it along a linear path. In the housing part (20) there is formed a receiving opening (30), through which the tile (5) or the like to be cut can be manually introduced into the cutting apparatus. In connection with the receiving opening there is provided an adjustable stopper means (1) which can be adjusted in such a way that the tile (5) or the like to be placed against it is positioned at the desired cutting point with respect to the path of the blade (2).

The invention relates to a portable apparatus for cutting tiles or the like, the cutting apparatus comprising a replaceable cutting blade which is arranged to move along a linear path, making a cutting incision on the surface of the tile or the like.

From the prior art are known various manually operated tile cutters in which the cutting blade is arranged to travel along linear guides by manual operation. Circular saw type tile cutters with diamond blades are also known. The problem with these circular saw type cutters is their noisiness and dust formation, as well as the risk of small pieces detaching from the tiles and flying at high speed onto the hands or face of the operator. These types of devices require meticulous protection and an efficient dust-removal arrangement in order to keep the surroundings clean for the purpose of tiling. Such circular saw type devices are often kept further away from the actual worksite to prevent dust and loose particles from ending up on the base to be tiled.

From the publication WO2009/109837 is known an apparatus for cutting tiles or the like, which comprises a first conveying means for introducing a tile into the cutting apparatus and a second conveying means for extracting the tile from the cutting apparatus. This solution requires the use of several motors, which makes it a heavy and complex construction unsuitable for a portable apparatus and better suited for factory conditions.

The aim of the present invention is to provide a relatively small portable tile cutting apparatus which facilitates the cutting of tiles and the like without causing considerable noise or dust nuisance and speeds up work considerably, and which cutting apparatus is easy to carry to a worksite since the apparatus can easily be realised as an apparatus only weighing a few kilograms, and which can also be made battery-driven. A further aim is to provide an easy-to-use cutting apparatus, which can be used with one hand.

To achieve this aim, the cutting apparatus according to the invention is characterised in that in the housing part is formed a receiving opening, through which the tile or the like to be cut can be manually introduced into the cutting apparatus; and that in connection with the receiving opening is provided an adjustable stopper means which can be adjusted in such a way that the tile or the like to be placed against it is positioned at the desired cutting point with respect to the path of the blade.

The invention is described in greater detail in the following, with reference to the accompanying drawings, in which:

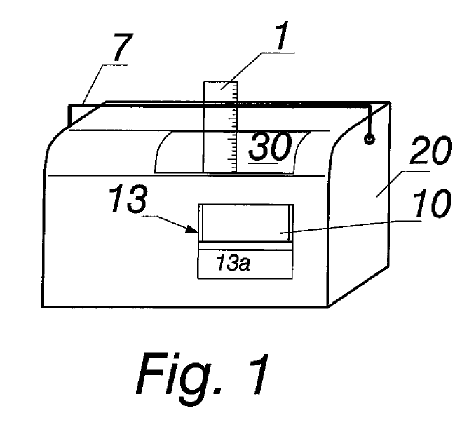

FIG. 1 shows a diagrammatic view in principle of an application of the cutting apparatus according to the invention,

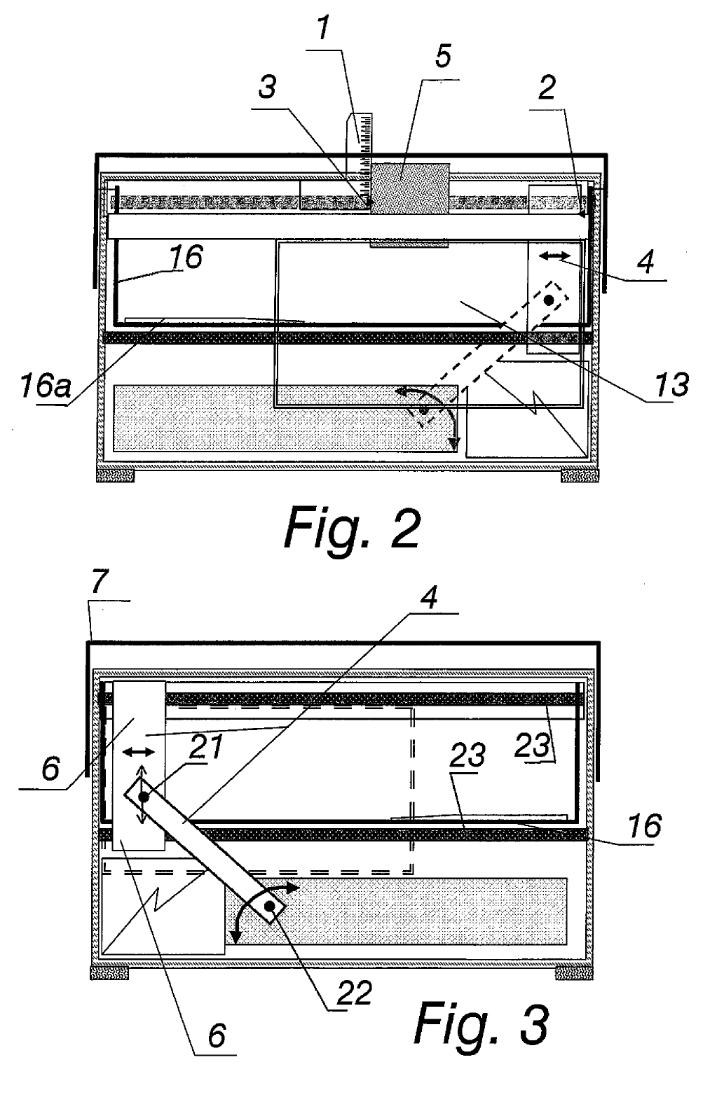

FIG. 2 shows a cross-sectional view of the cutting apparatus of FIG. 1 as seen from the front,

FIG. 3 shows a cross-sectional view of the cutting apparatus of FIG. 1 as seen from the rear, and

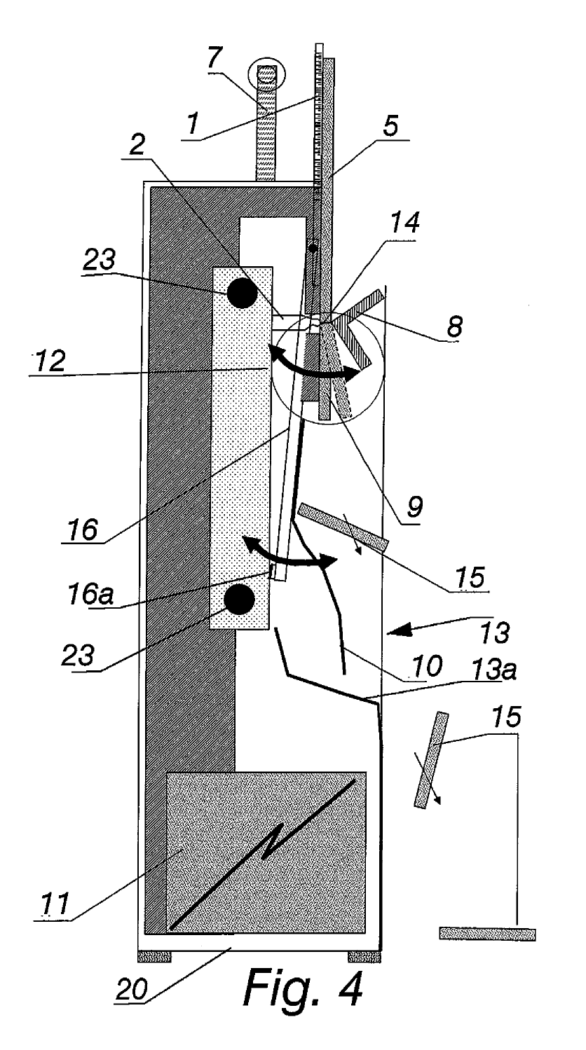

FIG. 4 shows a cross-sectional view of the cutting apparatus of FIG. 1 as seen from the side.

The cutting apparatus according to a preferred embodiment of the invention depicted in FIGS. 1-4 comprises a body or housing part 20, in the upper part of which is made a receiving opening 30 for the tiles to be cut. On the front side of the body part 20 is made a discharge opening 13 for the parts detached from the tiles. The apparatus is preferably provided with a carry handle 7 to facilitate the moving of the apparatus.

Inside the body part 20 are arranged linear guides 23 and a carriage 6 travelling along them. To the carriage 6 is fixed a cutting blade 2 which consists of an arm part and a diamond blade. In the embodiment shown, the carriage 6 is arranged to travel back and forth along the linear guides 23 by means of a motor 11 provided in the body part. The carriage 6 is connected to the output shaft 22 of the motor 11 by means of an articulated arm 4 which turns back and forth along a curved path with the rotary movement of the output shaft 22. The fixing point 21 of the articulated arm 4 on the carriage 6 is arranged to move in the longitudinal direction of the carriage 6, thus allowing the carriage to travel along the linear guides 23 as the output shaft 22 turns clockwise or anti-clockwise. In the body part 20 is in addition provided a stopper means 1 which can be adjusted in such a way that the tile 5 to be cut can be placed in the desired position with respect to the path of the cutting blade 2. The stopper 1 is preferably provided with a scale in order that the cutting point of the tile 5 can be placed at exactly the desired point. The tiles are placed in the opening 30 manually against the stopper 1. The stopper 1 is preferably manually operated. In the apparatus is preferably provided a contact switch 3 which starts the apparatus automatically when a tile is placed against the stopper 1. Instead of a contact switch 3, there may be a different indicator in the apparatus which starts the apparatus when the tile is in the correct position with respect to the path of the cutting blade 2. When the apparatus starts, the carriage begins to move along the linear guides 23 and the cutting blade 2 makes a cutting incision on the surface of the tile 5, and as the carriage moves forward past the tile, the carriage impacts with a rocker lever 16, on the lower edge of which is arranged a stopper part 16a, on impacting with which the carriage 6 causes the rocker lever 16 to be pushed outwards and a pressing part 16b on the rocker lever simultaneously presses the tile 5 against the tip of a support means 8 located essentially at the cutting incision and then the part 9 of the tile 5 beneath the cutting incision outwards around the tip of the support means 8, thus causing it to detach from the remaining part of the tile 5. This detached part 15 discharges from the apparatus automatically through a discharge opening made in the body part, pushed by a pusher part 10 connected to the rocker lever. The part of the tile in the receiving opening 30 may be removed manually by lifting by its upper edge. The apparatus may also comprise lifting means for lifting the tile part in the opening 30 upwards to facilitate its removal. The lifting means may be, for example, spring-actuated.

The motor is preferably electrically driven and may acquire the required electric power, for example, from a battery or a mains current source.

The sole purpose of the embodiment described above is to describe a preferred embodiment of the invention, however, without being restricted to it.

For example, instead of being operated by an articulated arm, the carriage may be operated, for example, by a toothed belt or chain or screw. Furthermore, the linear guides can be made, for example, as guide bars formed on the body part and their number may be one or more than two. Moreover, the term “linear” is used in this application to cover both a rectilinear path and a path proceeding in a curved or winding manner. The desired path of the cutting blade may be realised, for example, by arranging it to move with respect to the carriage as the carriage proceeds along the guides or by arranging the movement of the carriage to be controlled in a manner implementing the desired path.

With the solution according to the invention is achieved a compact, relatively simple and reliable portable tile cutting apparatus, which is easy to take to a worksite and which facilitates and speeds up tiling work substantially compared with manual devices. By means of the cutter can be carried out the dimensioning of the tile, the start-up of the cutting apparatus, the making of the cutting incision and the cutting at the cutting incision, all at the same time and with one hand.

1. A portable apparatus for cutting tiles (5) or the like, the cutting apparatus comprising a housing part (20), inside which is fitted a carriage part (6), which is arranged to be moved in a power-driven manner by a motor means (11) provided in the housing part, along a linear path, to which carriage part is fixed a replaceable cutting blade (2) which is arranged to move with the carriage part (6) and to make the desired cutting incision on the surface of the tile or the like, characterised in that in the housing part (20) is formed a receiving opening (30), through which the tile (5) or the like to be cut can be manually introduced into the cutting apparatus; and that in connection with the receiving opening is provided an adjustable stopper means (1) which can be adjusted in such a way that the tile (5) or the like to be placed against it is positioned at the desired cutting point with respect to the path of the blade (2).

2. A cutting apparatus as claimed in claim 1, characterised in that the cutting apparatus comprises means (16, 16 a) which carry out the detaching of the part (9) to be removed from the remainder of the tile (5) or the like automatically along the cutting incision made with the cutting blade.

3. A cutting apparatus as claimed in claim 1, characterised in that the cutting apparatus comprises detector means (3) for detecting the location of the tile or the like to be cut against the stopper means (1) and start the automatic cutting and detaching process.

4. A cutting apparatus as claimed in claim 1, characterised in that the cutting device has a manually operated starting switch.

5. A cutting apparatus as claimed in claim 1, characterised in that the motor (11) is electrically driven.

6. A cutting apparatus as claimed in claim 1, characterised in that the carriage part (6) is arranged to move along a pair of linear guides (23) positioned at a distance from one another and is connected to the power output shaft (22) of the motor (11) by means of an articulated arm (4), the fixing point (21) of which in the carriage part (6) can move in the transverse direction with respect to the linear guides as the articulated arm (4) turns with the rotary movement of the output shaft (22).

7. A cutting apparatus as claimed in claim 1, characterised in that the carriage part (6) is arranged to move along a pair of linear guides (23) positioned at a distance from one another and is connected to the motor (11) by means of a toothed belt or chain or screw axis.
